(19) United States
(12) Patent Application Publication
(10) Pub. No.: US 2022/0188616 A1
(43) Pub. Date: Jun. 16, 2022

(54) DATA PROCESSING APPARATUS

(71) Applicant: DENSO CORPORATION, Kariya-city (JP)

(72) Inventors: Masafumi MORI, Kariya-city (JP); Mitsuru AMBAI, Tokyo (JP)

(21) Appl. No.: 17/653,095

(22) Filed: Mar. 1, 2022

Related U.S. Application Data
(63) Continuation of application No. PCT/JP2020/033063, filed on Sep. 1, 2020.

(30) Foreign Application Priority Data
Sep. 2, 2019 (JP) 2019-159501

(51) Int. Cl. G06N 3/063

(52) U.S. Cl. CPC G06N 3/063; G06N 3/082

(57) ABSTRACT

In a data processing apparatus, an M×M data processing unit performs M×M convolution processing using data from an input buffer unit. An N×N data processing unit performs N×N convolution processing using the data from the input buffer unit. A first output buffer unit stores one of results of processing by the M×M data processing unit and the N×N data processing unit, and outputs the same to the input buffer unit. A second output buffer unit stores the other of the results of processing by the M×M data processing unit and the N×N data processing unit. The second output buffer unit transfers the result of processing to the external memory.

### CROSS-REFERENCE TO RELATED APPLICATION

This application is a continuation application of International Application No. PCT/JP2020/033063 filed Sep. 1, 2020 which designated the U.S. and claims priority to Japanese Patent Application No. 2019-159501 filed with the Japan Patent Office on Sep. 2, 2019, the contents of each of which are incorporated herein by reference.

### BACKGROUND

### Technical Field

The present disclosure relates to a data processing apparatus.

### Related Art

Methods are known for reducing the amount of computation by decomposing layers or adding compressed layers in an existing network.

### BRIEF DESCRIPTION OF THE DRAWINGS

In the accompanying drawings:

FIG. 1 is a block diagram illustrating a configuration of a data processing apparatus according to a first embodiment;

FIG. 2 is a diagram for describing data sizes of an intermediate feature amount and an output feature amount;

FIG. 3 is a diagram illustrating an example of cycles in which data accesses to an external memory take places;

FIG. 4 is a diagram for describing two decomposition methods;

FIG. 5 is a flowchart illustrating a flow of convolution operation control processing by the data processing apparatus according to the first embodiment;

FIG. 6 is a flowchart illustrating a flow of convolution operation control processing by the data processing apparatus according to the first embodiment;

FIG. 7 is a diagram illustrating an example of a flow of convolution operations by each convolution layer;

FIG. 8 is a diagram for describing operations of the data processing apparatus according to the first embodiment;

FIG. 9 is a diagram for describing operations of the data processing apparatus according to the first embodiment;

FIG. 10 is a diagram for describing operations of the data processing apparatus according to the first embodiment;

FIG. 11 is a diagram for describing operations of the data processing apparatus according to the first embodiment;

FIG. 12 is a diagram for describing operations of the data processing apparatus according to the first embodiment;

FIG. 13 is a diagram for describing operations of the data processing apparatus according to the first embodiment;

FIG. 14 is a diagram for describing operations of the data processing apparatus according to the first embodiment;

FIG. 15 is a diagram for describing operations of the data processing apparatus according to the first embodiment;

FIG. 16 is a diagram illustrating an example of a flow of convolution operations by each convolution layer;

FIG. 17 is a diagram for describing operations of the data processing apparatus according to the first embodiment;

FIG. 18 is a diagram for describing operations of the data processing apparatus according to the first embodiment;

FIG. 19 is a diagram for describing operations of the data processing apparatus according to the first embodiment;

FIG. 20 is a diagram for describing operations of the data processing apparatus according to the first embodiment;

FIG. 21 is a diagram for describing operations of the data processing apparatus according to the first embodiment;

FIG. 22 is a diagram for describing operations of the data processing apparatus according to the first embodiment;

FIG. 23 is a diagram for describing operations of the data processing apparatus according to the first embodiment;

FIG. 24 is a diagram for describing operations of the data processing apparatus according to the first embodiment;

FIG. 25A is a diagram illustrating an example of a change in the cycle in which a data access to the external memory takes place;

FIG. 25B is a diagram illustrating an example of a change in the cycle in which a data access to the external memory takes place;

FIG. 26 is a block diagram for describing a configuration of a data processing apparatus according to a second embodiment;

FIG. 27 is a block diagram illustrating a configuration of a computation unit in the data processing apparatus according to the second embodiment;

FIG. 28 is a flowchart illustrating a flow of convolution operation control processing by the data processing apparatus according to the second embodiment;

FIG. 29 is a flowchart illustrating a flow of convolution operation control processing by the data processing apparatus according to the second embodiment; and

FIG. 30 is a diagram for describing generation of intermediate feature amounts of convolution operations due to decomposition of layers or insertion of compressed layers.

### DESCRIPTION OF SPECIFIC EMBODIMENTS

JP 2017-525038 A describes a method for decomposing a filter in a convolutional neural network (CNN).

JP 2018-506785 A describes a method for inserting a compressed layer.

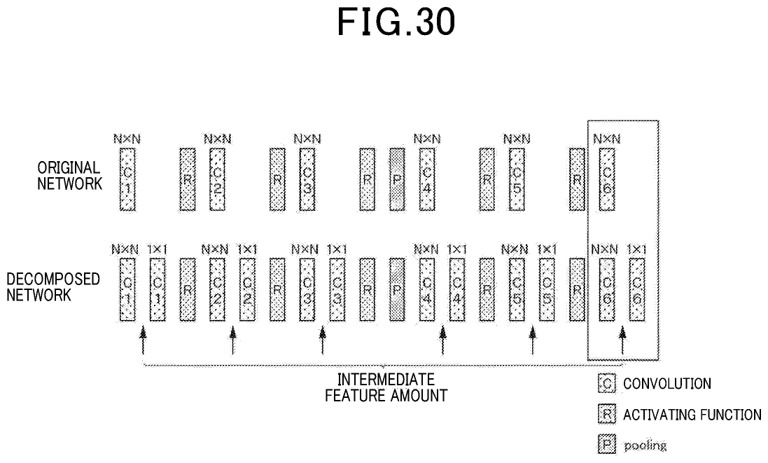

However, according to the methods in JP 2017-525038 A and JP 2018-506785 A, there occurs an intermediate feature amount that is a feature amount of a convolution operation due to the decomposition of a layer or insertion of a compressed layer. The inventor has found a problem that, if the intermediate feature amount is large in size and needs to be written into an external memory, the number of accesses to the external memory will increase in hardware environments where a computation is performed on each layer as described in J. Qiu et al, “Going Deeper with Embedded FPGA Platform for Convolutional Neural Network”, FPGA 2016 (see FIG. 30).

In view of the foregoing, it is desired to have a technique for achieving speedup of convolution processing while suppressing an increase in the number of accesses to an external memory.

A first aspect of the present disclosure provides a data processing apparatus including: an external memory that stores processing target data; an input buffer unit that stores at least part of the data stored in the external memory; an M×M data processing unit that performs M×M convolution processing using the data stored in the input buffer unit; an N×N data processing unit that performs N×N convolution processing using the data stored in the input buffer unit; a first output buffer unit that stores one of results of processing by the M×M data processing unit and the N×N data processing unit; and a second output buffer unit that stores the other of the results of processing by the M×M data processing unit and the N×N data processing unit. The results of processing stored in the first output buffer unit is stored in the input buffer unit, and the results of processing stored in the second output buffer unit is transferred to the external memory. This makes it possible to achieve speedup of convolution processing while suppressing an increase in the number of accesses to the external memory. Specifically, the two convolution operations can be performed in parallel, so that the number of times a large-size feature amount is saved in the external memory can be decreased by half.

A second aspect of the present disclosure provides a computer-readable storage media having instructions stored thereon that, when executed by a computer including an external memory storing processing target data, cause the computer to function as: an input processing unit that stores at least part of the data stored in the external memory; an M×M data processing unit that performs M×M convolution processing using the data from the input processing unit; an N×N data processing unit that performs N×N convolution processing using the data from the input processing unit; a first output processing unit that stores one of results of processing by the M×M data processing unit and the N×N data processing unit; and a second output processing unit that stores the other of the results of processing by the M×M data processing unit and the N×N data processing unit. The first output processing unit stores the results of processing in the input processing unit, and the second output processing unit transfers the results of processing to the external memory. This makes it possible to achieve speedup of convolution processing while suppressing an increase in the number of accesses to the external memory. Specifically, the two convolution operations can be performed in parallel, so that the number of times a large-size feature amount is saved in the external memory can be decreased by half.

### Overview of Embodiment

Hereinafter, embodiments of a data processing apparatus according to the present disclosure will be described with reference to the drawings.

In the present embodiment, as a countermeasure against a problem of the occurrence of data accesses for intermediate feature amounts, two layers are subjected to pipeline processing to reduce the number of accesses to an external memory for intermediate feature amounts.

Specifically, on the assumption that decomposition is performed by Singular Value Decomposition (SVD), an M×M data processing unit 56A by which to perform convolution using an M×M filter and an N×N data processing unit 56B by which to perform convolution using an N×N filter are prepared to perform parallel computations. A wiring line is prepared to write a computation result from a first output buffer unit 58A saving the computation result into an input buffer unit 54 inputting data back to the M×M data processing unit 56A and the N×N data processing unit 56B. For example, using SVD, M×M convolution layers can be decomposed into 1×1 convolution layers. This makes it possible to efficiently perform layer operations involving a large amount of computation or a large number of parameters (data amount).

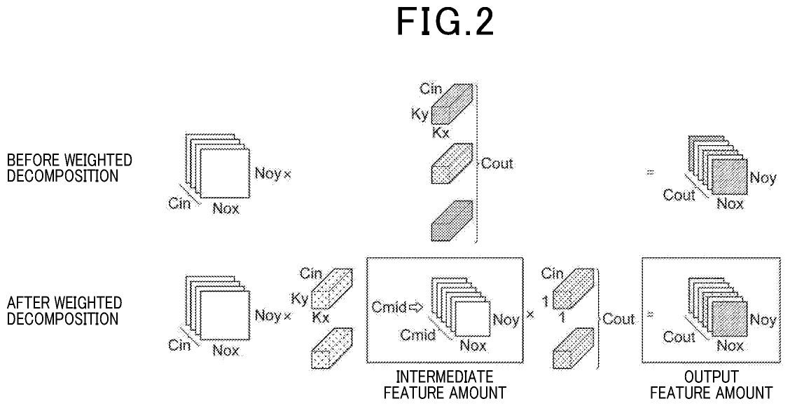

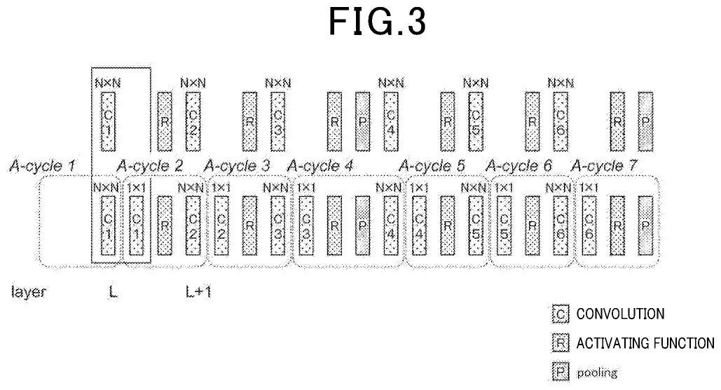

As illustrated in FIG. 2, the intermediate feature amount that is the processing result of a convolution operation on layers decomposed by SVD is smaller in data size than the original output feature amount. Thus, the output feature amount of large data size is subjected to pipeline processing so as not to cause a data access to the external memory. On the other hand, the intermediate feature amount of small data size is transferred to the external memory, thereby decreasing data accesses to the external memory (see FIG. 3). That is, in processing cycle A-cycle as illustrated in FIG. 3, after a 1×1 convolution and an N×N convolution, the intermediate feature amount is transferred to the external memory.

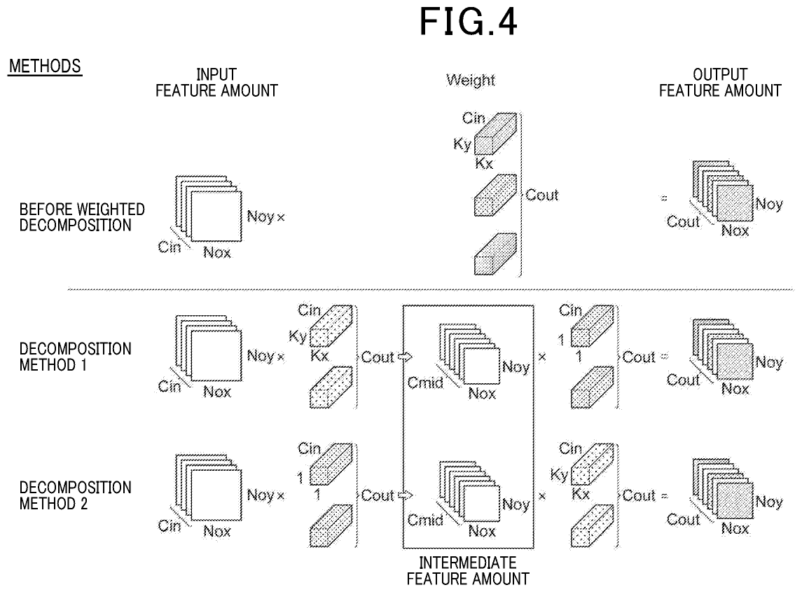

For example, the data size of the output feature amount is expressed by the following equation (see FIG. 4):

Cout*Nox*Noy*bit_width

In the equation, Cout is the number of channels of the output feature amount, Nox and Noy are sizes of the output feature amount along x direction and y direction, and bit_width is bit width.

The data size of the intermediate feature amount is expressed by the following equation:

Cmid*Nox*Noy*bit_width

In the equation, Cmid is the number of channels of the intermediate feature amount.

Therefore, if the number of channels Cmid of the intermediate feature amount is smaller than the number of channels Cout of the output feature amount, the data size of the intermediate feature amount is smaller than the data size of the output feature amount.

Since the feature amount of a deep neural network (DNN) is large and it is difficult to perform all operations on an on-chip memory, computations are performed on each layer (layer-by-layer) in the conventional technique. For example, the first layer output (activation 32 bit) of Visual Geometry Group (VGG) is 224*224*64*32/8≈12 MByte.

The decomposition by SVD (N×N convolution to 1×1 convolution, hereinafter, called decomposition method 1) has been described above. Besides, there is also a decomposition method 2 (1×1 convolution to N×N convolution) (see FIG. 4).

If the recognition accuracy can be assured in both the decomposition methods 1 and 2, the decomposition is performed while switching between these techniques in accordance with higher decomposition efficiency (depending on the number of input channels and the number of output channels).

That is, the intermediate feature amount is smaller than the output feature amount according to both of the decomposition methods 1 and 2. Thus, in correspondence with the decomposition methods 1 and 2, switching takes place between a loop of repeating N×N convolution, transfer to the external memory, 1×1 convolution, N×N convolution . . . and a loop of repeating 1×1 convolution, transfer to the external memory, N×N convolution, 1×1 convolution, . . . .

The number of accesses to the feature amount necessary for the computation by the decomposition method 1 is expressed by the following equation:

Cin*Kx*Ky*Cmid*Nix*Niy+Cmid*Cout*Nox*Noy

In the equation, Kx and Ky are sizes of the filter, for example, Kx=N, Ky=N. Nix and Niy are sizes of the input feature amount in the x direction and the y direction.

The number of accesses to the feature amount necessary for the computation by the decomposition method 2 is expressed by the following equation:

Cin*Cmid*Nix*Niy+Cmid*Cout*Kx*Ky*Nox*Noy

Therefore, if the number of Cmid is the same, in the case of Cin>Cout, the number of accesses to the feature amount is smaller with the decomposition method 2, and thus the decomposition method 2 is used. In the case of Cin<Cout, the number of accesses to the feature amount is smaller with the decomposition method 1, and thus the decomposition method 1 is used.

As above, in the present embodiment, in the image processing using a neural network, each of the convolution layers is decomposed by SVD, or 1×1 convolution and N×N convolution are included. The image processing is performed by the loop of repeating N×N convolution, transfer to the external memory, 1×1 convolution, and N×N convolution, . . . or the loop of repeating 1×1 convolution, transfer to the external memory, N×N convolution, 1×1 convolution, . . . , using either of the decomposition methods 1 and 2, which is determined in accordance with the recognition accuracy, the number of input channels, and the number of output channels for each of the convolution layers after decomposition.

### First Embodiment

Configuration of Data Processing Apparatus According to First Embodiment

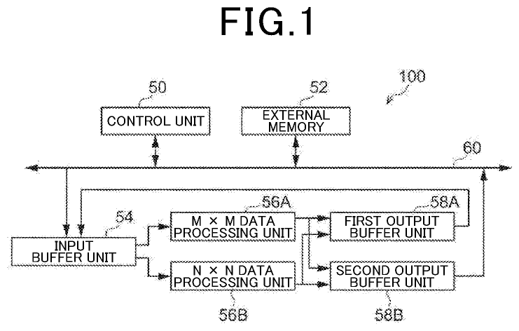

Here, a configuration of a data processing apparatus according to the present embodiment will be described. As illustrated in FIG. 1, a data processing apparatus 100 according to the present embodiment includes a control unit 50, an external memory 52, an input buffer unit 54, an M×M data processing unit 56A, an N×N data processing unit 56B, a first output buffer unit 58A, and a second output buffer unit 58B. The control unit 50, the external memory 52, the input buffer unit 54, the M×M data processing unit 56A, the N×N data processing unit 56B, the first output buffer unit 58A, and the second output buffer unit 58B are connected to one another via a bus 60. Herein, M and N are integers greater than or equal to 1, and M>N. The present embodiment will be described with M=3 and N=1 as an example.

The control unit 50 controls the external memory 52, the input buffer unit 54, the M×M data processing unit 56A, the N×N data processing unit 56B, the first output buffer unit 58A, and the second output buffer unit 58B.

The external memory 52 stores processing target data. The processing target data is, for example, a feature map to be subjected to a convolution operation. The external memory 52 further stores weight data related to filters, and others.

The input buffer unit 54 stores data from the external memory 52 or data from the first output buffer unit 58A.

The M×M data processing unit 56A performs M×M convolution processing using the data from the input buffer unit 54.

The N×N data processing unit 56B performs N×N convolution processing using the data from the input buffer unit 54.

The first output buffer unit 58A stores a result of processing by either one of the M×M data processing unit 56A and the N×N data processing unit 56B.

The second output buffer unit 58B stores a result of processing by the other of the M×M data processing unit 56A and the N×N data processing unit 56B. The second output buffer unit 58B transfers the processing result to the external memory 52.

The processing target data is data defined by three or more orthogonal axes, and 3×3 convolution processing or 1×1 convolution processing is performed on a first axis and a second axis in the processing target data.

If the number of data items belonging to the third axis in the data of a result of 3×3 convolution processing (for example, the number of channels of the intermediate feature amount) is smaller than the number of data items belonging to the third axis in the data of a result of 1×1 convolution processing (for example, the number of channels of the intermediate feature amount), the control unit 50 stores the result of processing by the M×M data processing unit 56A in the second output buffer unit 58B. Then, the control unit 50 controls the result of processing by the N×N data processing unit 56B to be stored in the first output buffer unit 58A.

If the number of data items belonging to the third axis in the data of a result of 1×1 convolution processing (for example, the number of channels of the intermediate feature amount) is smaller than the number of data items belonging to the third axis in the data of a result of 3×3 convolution processing (for example, the number of channels of the intermediate feature amount), the control unit 50 stores the result of processing by the N×N data processing unit 56B in the second output buffer unit 58B. Then, the control unit 50 controls the result of processing by the M×M data processing unit 56A to be stored in the first output buffer unit 58A.

Actions of Data Processing Apparatus According to First Embodiment

Next, actions of the data processing apparatus according to the present embodiment will be described.

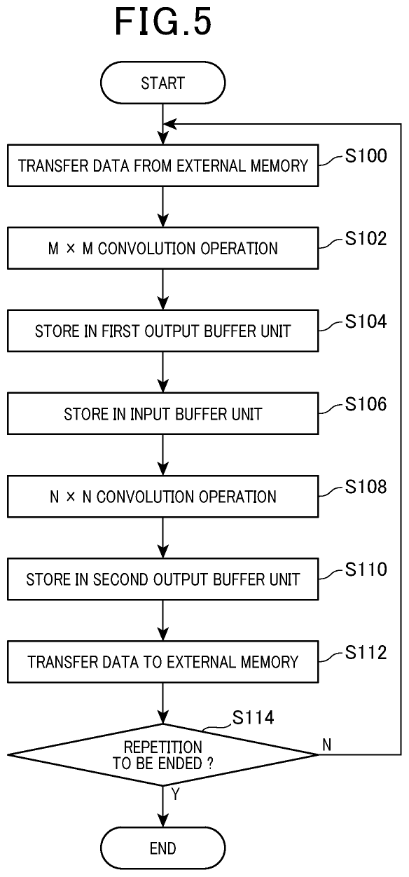

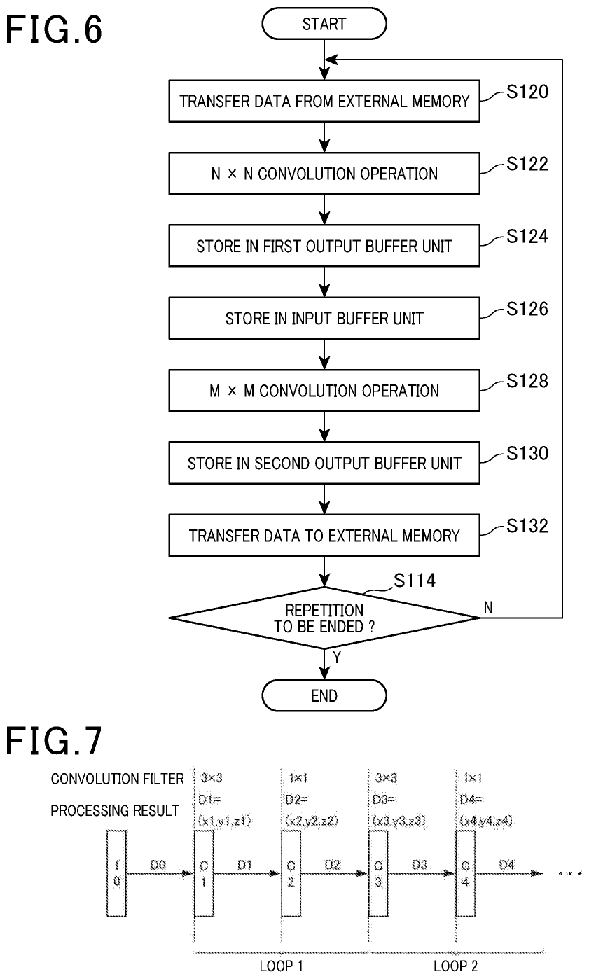

In the image processing using a neural network, each of convolution layers is decomposed by SVD, or 1×1 convolution and 3×3 convolution are included. For each of the convolution layers after decomposition, in the case of Cin<Cout, the control unit 50 repeats convolution operation control processing illustrated in FIG. 5, and in the case of Cin>Cout, the control unit 50 repeats convolution operation control processing illustrated in FIG. 6.

Next, the convolution operation control processing illustrated in FIG. 5 will be described. Herein, as an example, description will be provided as to the case of repeatedly executing a 3×3 convolution operation and a 1×1 convolution operation in sequence on processing target data D0 as an input as illustrated in FIG. 7 and storing the processing result in the external memory 52.

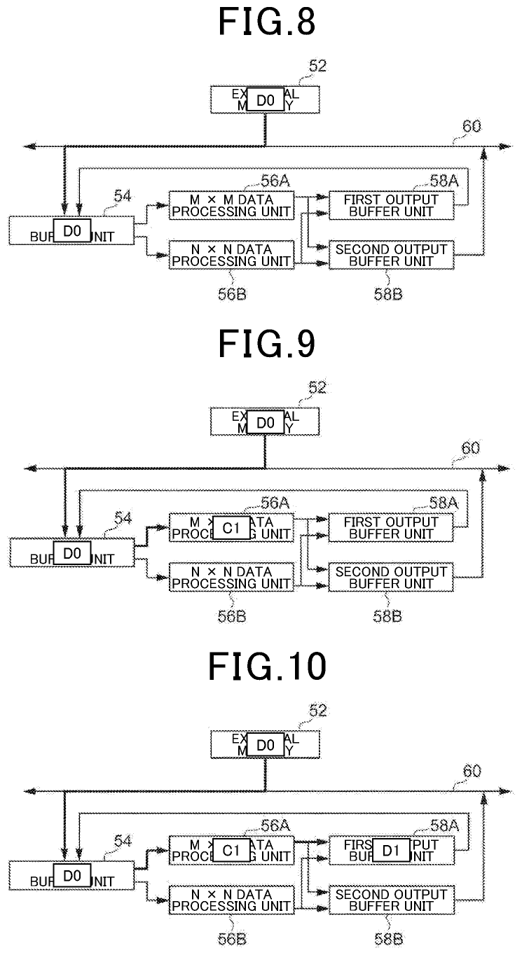

First, in step S100, the control unit 50 performs control to read the processing target data D0 from the external memory 52 and transfer the same to the input buffer unit 54, thereby storing the processing target data D0 in the input buffer unit 54 (see FIG. 8).

In step S102, the control unit 50 performs control to transfer the processing target data D0 stored in the input buffer unit 54 to the M×M data processing unit 56A and perform a 3×3 convolution operation C1 on the processing target data D0 (see FIG. 9).

In step S104, the control unit 50 performs control to store processing result data D1 of the 3×3 convolution operation C1 in the first output buffer unit 58A (see FIG. 10).

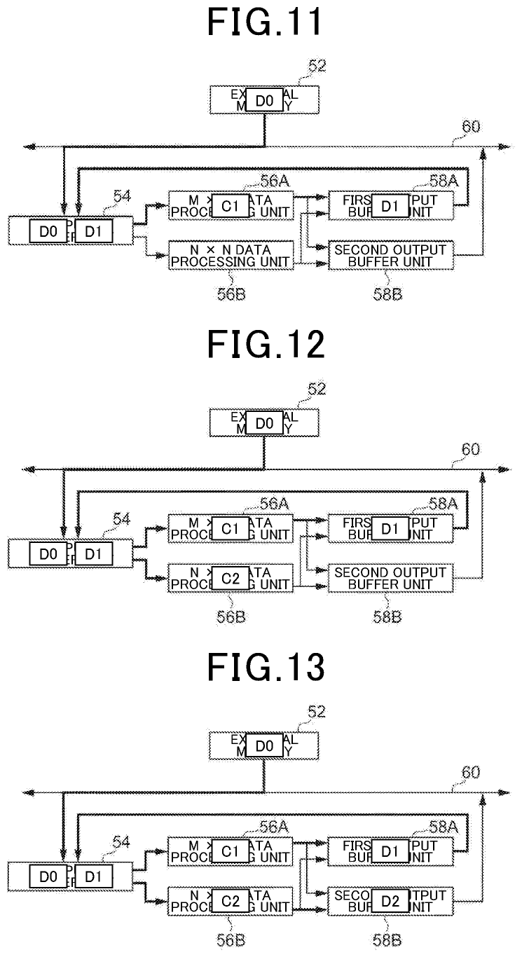

In step S106, the control unit 50 performs control to store the processing result data D1 stored in the first output buffer unit 58A, in the input buffer unit 54 (see FIG. 11).

In step S108, the control unit 50 performs control to input the processing result data D1 stored in the input buffer unit 54 to the N×N data processing unit 56B and perform a 1×1 convolution operation C2 on the processing result data D1 (see FIG. 12).

In step S110, the control unit 50 performs control to store processing result data D2 of the 1×1 convolution operation C2 in the second output buffer unit 58B (see FIG. 13).

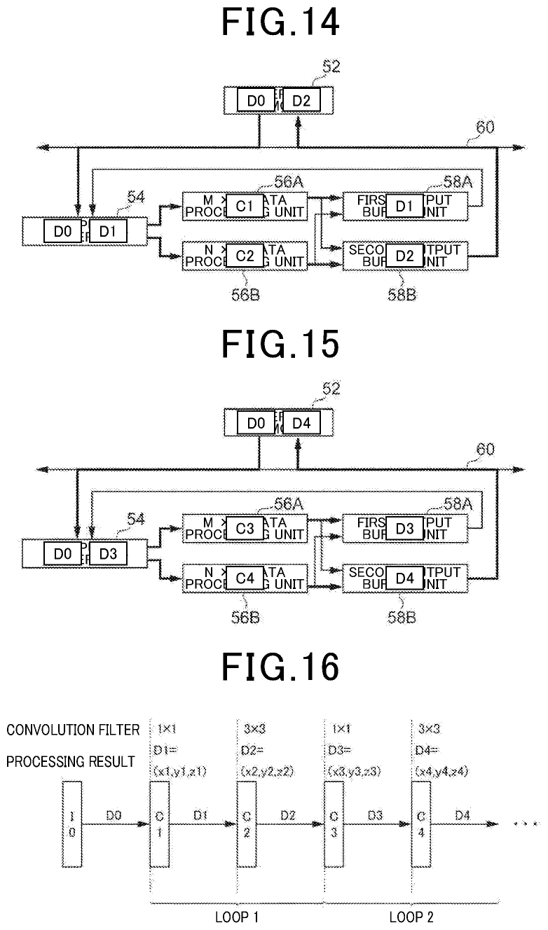

In step S112, the control unit 50 performs control to transfer the processing result data D2 stored in the second output buffer unit 58B to the external memory 52 (see FIG. 14).

In step S114, the control unit 50 determines whether to end the repeated processing. If the control unit 50 determines that the repeated processing is not to be ended, the processing returns to step S100 and the control unit 50 repeats steps S100 to S114 (see FIG. 15). On the other hand, if the control unit 50 determines that the repeated processing is to be ended, the control unit 50 ends the convolution operation control processing.

Next, the convolution operation control processing illustrated in FIG. 6 will be described. Herein, as an example, description will be provided as to the case of, with M=3 and N=1, repeatedly executing a 3×3 convolution operation and a 1×1 convolution operation in sequence on the processing target data D0 as an input as illustrated in FIG. 16 and storing the processing result in the external memory 52.

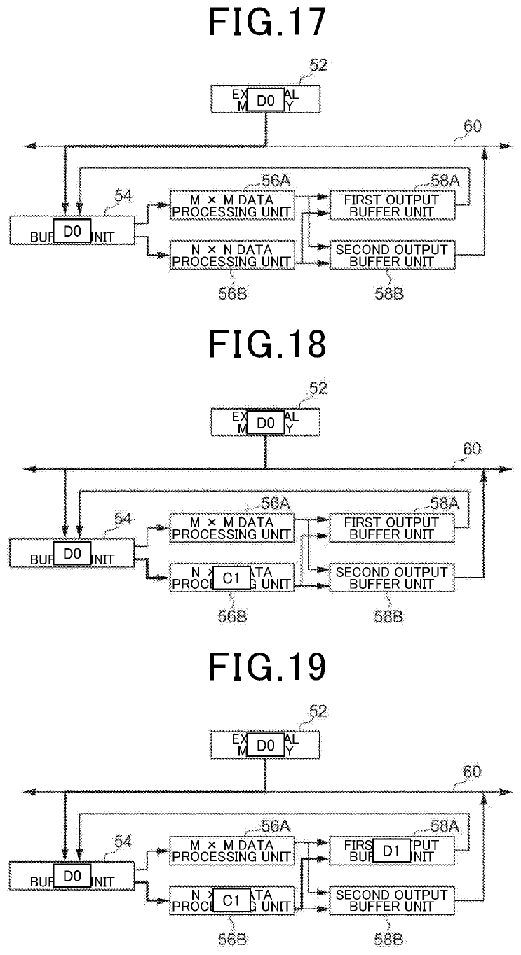

First, in step S120, the control unit 50 performs control to transfer the processing target data D0 from the external memory 52 to the input buffer unit 54 and stores the processing target data D0 in the input buffer unit 54 (see FIG. 17).

In step S122, the control unit 50 performs control to input the processing target data D0 stored in the input buffer unit 54 to the N×N data processing unit 56B and perform the 1×1 convolution operation C1 on the processing target data D0 (see FIG. 18).

In step S124, the control unit 50 performs control to store the processing result data D1 of the 1×1 convolution operation C1 in the first output buffer unit 58A (see FIG. 19).

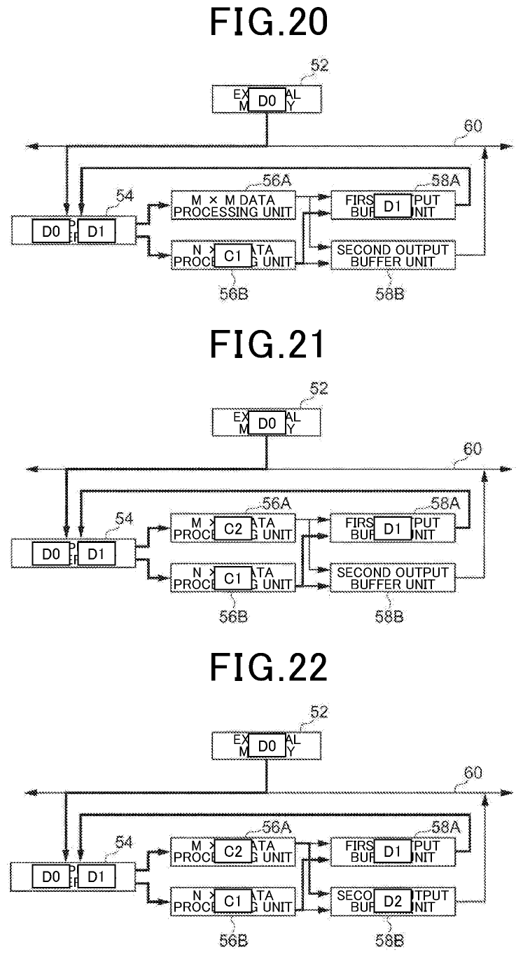

In step S126, the control unit 50 performs control to store the processing result data D1 stored in the first output buffer unit 58A, in the input buffer unit 54 (see FIG. 20).

In step S128, the control unit 50 performs control to input the processing result data D1 stored in the input buffer unit 54 to the M×M data processing unit 56A and perform the 3×3 convolution operation C2 on the processing result data D1 (see FIG. 21).

In step S130, the control unit 50 performs control to store the processing result data D2 of the 3×3 convolution operation C2 in the second output buffer unit 58B (see FIG. 22).

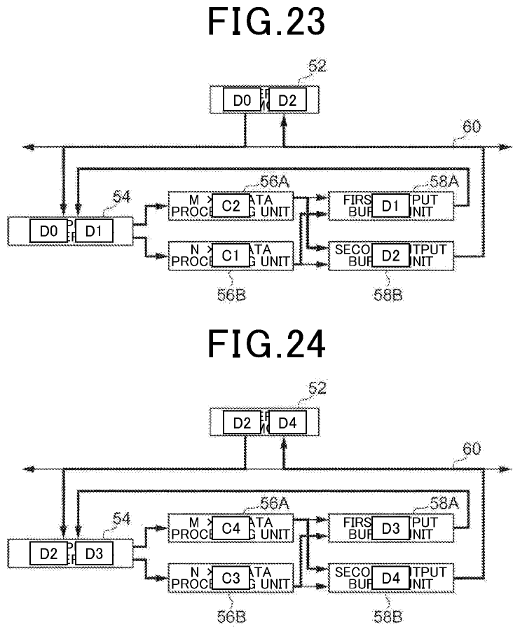

In step S132, the control unit 50 performs control to transfer the processing result data D2 stored in the second output buffer unit 58B to the external memory 52 (see FIG. 23).

In step S134, the control unit 50 determines whether to end the repeated process. If the control unit 50 determines that the repeated processing is not to be ended, the processing returns to step S120 and the control unit 50 repeats steps S120 to S134 (see FIG. 24). On the other hand, if the control unit 50 determines that the repeated processing to be ended, the convolution operation control processing is ended.

In the above-described example, the magnitude relationship between the number of input channels Cin and the number of output channels Cout is the same among the convolution layers. However, the magnitude relationship between the number of input channels Cin and the number of output channels Cout may be changed at an intermediate convolution layer in the neural network.

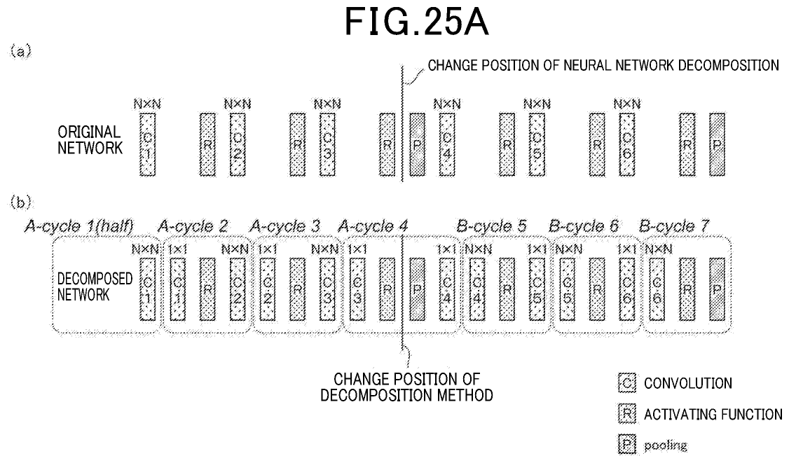

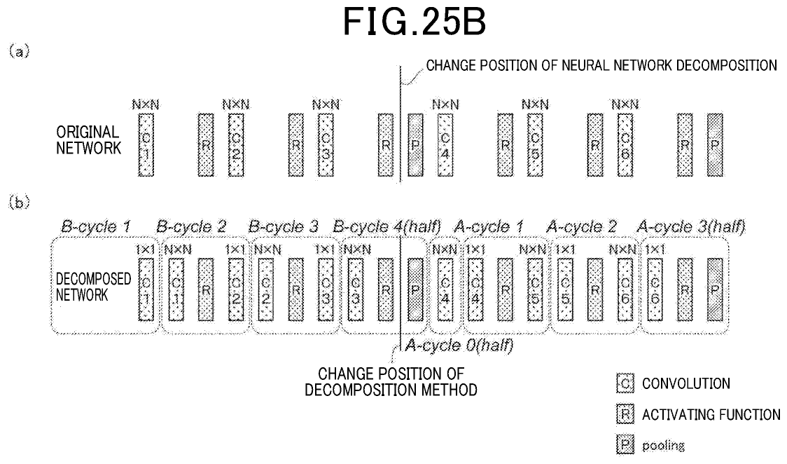

For example, if an original network illustrated in FIG. 25A(a) is decomposed with a change of the decomposition method in the middle of the processing as illustrated in FIG. 25A(b), switching takes place from a cycle (A-cycle) of repeating 1×1 convolution, N×N convolution, and transfer to the external memory, . . . to a cycle (B-cycle) of repeating N×N convolution, 1×1 convolution, and transfer to the external memory, . . . . At the timing of cycle switching, there occur 1×1 convolution to 1×1 convolution operations. In the case of 1<N, the 1×1 convolution operations can be processed by the N×N data processing unit 56B, and thus the cycle is executed crossing the change position. In this case, before the cycle switching, the convolution operation control processing in FIG. 5 is repeated, and after the cycle switching, the convolution operation control processing in FIG. 6 is repeated.

Otherwise, if an original network illustrated in FIG. 25B(a) is decomposed with a change of the decomposition method in the middle of the processing as illustrated in FIG. 25B(b), switching takes place from the cycle (B-cycle) of repeating N×N convolution, 1×1 convolution, and transfer to the external memory, . . . to the cycle (A-cycle) of repeating 1×1 convolution, N×N convolution, and transfer to the external memory, . . . . At the timing of cycle switching, there occur N×N convolution to N×N convolution operations. Since the N×N convolution to the N×N convolution operations are performed by the same data processing unit, the operation cycle is halved. In this case, before the cycle switching, the convolution operation control processing in FIG. 6 is repeated, and after the cycle switching, the convolution operation control processing in FIG. 5 is repeated.

As described above, in the data processing apparatus according to the embodiment of the present disclosure, the first output buffer unit stores the results of the convolution operation performed by either one of the M×M data processing unit and the N×N data processing unit in the input buffer unit. The second output buffer unit transfers the results of the convolution operation by the other of the M×M data processing unit and the N×N data processing unit to the external memory. This makes it possible to achieve speedup of the convolution processing while suppressing an increase in the number of accesses to the external memory. Specifically, two convolution operations are performed in parallel and the computation of the layer next to the layer with a large feature amount is executed in succession, so that the number of times the feature amount is saved in the external memory is decreased by half.

In the data processing apparatus according to the embodiment of the present disclosure, if the number of data items belonging to the third axis in the data of a result of the M×M convolution processing is smaller than the number of data items belonging to the third axis in the data of a result of the N×N convolution processing, the result of processing by the M×M data processing unit is stored in the second output buffer unit. Then, the result of processing by the N×N data processing unit is stored in the first output buffer unit. This makes it possible to suppress transfer to the external memory while assuring a reduction in the number of operations on the network of the structure of the decomposition method 1.

In the data processing apparatus according to the embodiment of the present disclosure, if the number of data items belonging to the third axis in the data of a result of the N×N convolution processing is smaller than the number of data items belonging to the third axis in the data of a result of the M×M convolution processing, the result of processing by the N×N data processing unit is stored in the second output buffer unit. Then, the result of processing by the M×M data processing unit is stored in the first output buffer unit. This makes it possible to suppress transfer to the external memory while assuring a reduction in the number of operations on the network of the structure of the decomposition method 2.

### Second Embodiment

Configuration of Data Processing Apparatus According to Second Embodiment

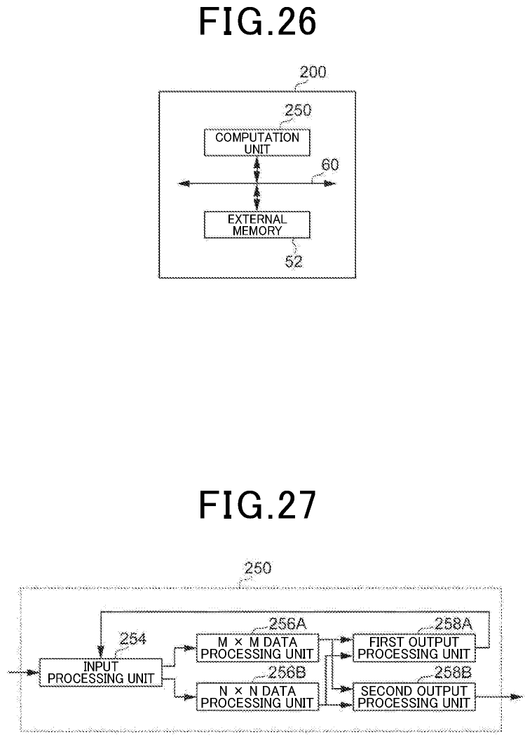

Next, a configuration of a data processing apparatus according to the present embodiment will be described. As illustrated in FIG. 26, a data processing apparatus 200 according to the present embodiment includes a computation unit 250 and an external memory 52. The computation unit 250 and the external memory 52 are connected to each other via a bus 60.

The computation unit 250 can be configured with a computer including a central processing unit (CPU), a random-access memory (RAM), and a read only memory (ROM) storing programs and various data for executing processing routines described later.

As illustrated in FIG. 27, the computation unit 250 functionally includes an input processing unit 254, an M×M data processing unit 256A, an N×N data processing unit 256B, a first output processing unit 258A, and a second output processing unit 258B. In this configuration, M and N are integers greater than or equal to 1, and M>N. The present embodiment will be described with M=3 and N=1 as an example.

The input processing unit 254 stores data from the external memory 52 or the data from the first output processing unit 258A in the RAM. The input processing unit 254 also outputs the data stored in the RAM to the M×M data processing unit 256A or the N×N data processing unit 256B.

The M×M data processing unit 256A performs 3×3 convolution processing using the data from the input processing unit 254.

The N×N data processing unit 256B performs 1×1 convolution processing using the data from the input processing unit 254.

The first output processing unit 258A stores the result of processing by either one of the M×M data processing unit 256A and the N×N data processing unit 256B in the RAM. The first output processing unit 258A also outputs the data stored in the RAM to the input processing unit 254.

The second output processing unit 258B stores the result of processing by the other of the M×M data processing unit 256A and the N×N data processing unit 256B in the RAM. The second output processing unit 258B also transfers the result of processing stored in the RAM to the external memory 52.

The processing target data is data defined by three or more orthogonal axes. 3×3 convolution processing or 1×1 convolution processing is performed on a first axis and a second axis in the processing target data.

If the number of data items belonging to the third axis in the data of a result of the 3×3 convolution processing (for example, the number of channels of the intermediate feature amount) is smaller than the number of data items belonging to the third axis in the data of a result of the 1×1 convolution processing (for example, the number of channels of the intermediate feature amount), the M×M data processing unit 256A outputs the result of the 3×3 convolution processing to the second output processing unit 258B. The N×N data processing unit 256B outputs the result of the 1×1 convolution processing to the first output processing unit 258A.

If the number of data items belonging to the third axis in the data of a result of the 3×3 convolution processing (for example, the number of channels of the intermediate feature amount) is smaller than the number of data items belonging to the third axis in the data of a result of the 3×3 convolution processing (for example, the number of channels of the intermediate feature amount), the N×N data processing unit 256B outputs the result of the 1×1 convolution processing to the second output processing unit 258B. The M×M data processing unit 256A outputs the result of the M×M convolution processing to the first output processing unit 258A.

Actions of Data Processing Apparatus According to Second Embodiment

Next, actions of the data processing apparatus according to the present embodiment will be described.

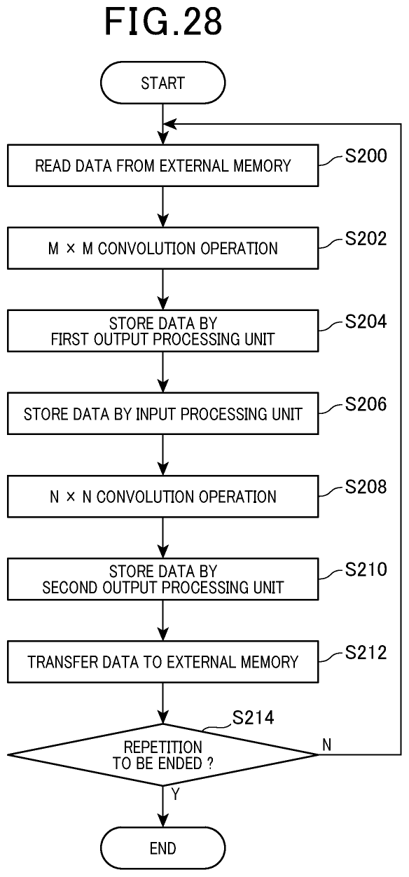

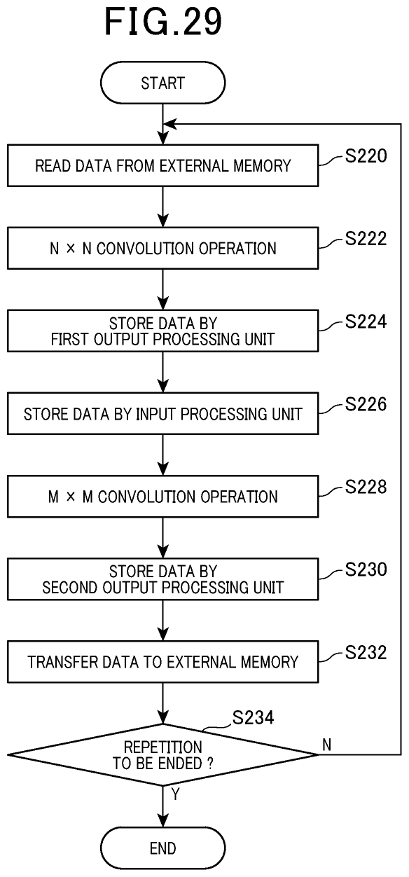

In the image processing using a neural network, each of the convolution layers is decomposed by SVD. For each of the decomposed convolution layers, in the case of Cin<Cout, the computation unit 250 repeats convolution operation control processing illustrated in FIG. 28, and in the case of Cin>Cout, the computation unit 250 repeats convolution operation control processing illustrated in FIG. 29.

Next, the convolution operation control processing illustrated in FIG. 28 will be described. Herein, as an example, description will be provided as to the case of repeatedly executing a 3×3 convolution operation and a 1×1 convolution operation in sequence on the processing target data D0 as an input as illustrated in FIG. 7 and storing the processing result in the external memory 52.

First, in step S200, the computation unit 250 performs control to read the processing target data D0 from the external memory 52 and transfer the same to the input processing unit 254. As the input processing unit 254, the computation unit 250 stores the processing target data D0 in the RAM.

In step S202, as the input processing unit 254, the computation unit 250 inputs the processing target data D0 stored in the RAM to the M×M data processing unit 256A. As the M×M data processing unit 256A, the computation unit 250 performs a 3×3 convolution operation C1.

In step S204, as the M×M data processing unit 256A, the computation unit 250 outputs processing result data D1 of the 3×3 convolution operation C1 to the first output processing unit 258A. As the first output processing unit 258A, the computation unit 250 stores the processing result data D1 in the RAM.

In step S206, as the first output processing unit 258A, the computation unit 250 outputs the processing result data D1 stored in the RAM to the input processing unit 254. As the input processing unit 254, the computation unit 250 stores the processing result data D1 in the RAM.

In step S208, as the input processing unit 254, the computation unit 250 inputs the processing result data D1 stored in the RAM to the N×N data processing unit 256B. As the N×N data processing unit 256B, the computation unit 250 performs a 1×1 convolution operation C2.

In step S210, as the N×N data processing unit 256B, the computation unit 250 outputs processing result data D2 of the 1×1 convolution operation C2 to the second output processing unit 258B. As the second output processing unit 258B, the computation unit 250 stores the processing result data D2 in the RAM.

In step S212, as the second output processing unit 258B, the computation unit 250 transfers the processing result data D2 stored in the RAM to the external memory 52.

In step S214, the computation unit 250 determines whether to end the repeated processing. If the computation unit 250 determines that the repeated processing is not to be ended, the processing returns to step S200 and the computation unit 250 repeats steps S200 to S214. On the other hand, if the computation unit 250 determines that the repeated processing is to be ended, the convolution operation control processing is ended.

Next, the convolution operation control processing illustrated in FIG. 29 will be described. Herein, as an example, description will be provided as to the case of repeatedly executing a combination of a 1×1 convolution operation and a 3×3 convolution operation on the processing target data D0 as an input as illustrated in FIG. 16.

First, in step S220, the computation unit 250 performs control to transfer the processing target data D0 from the external memory 52 to the input processing unit 254. As the input processing unit 254, the computation unit 250 stores the processing target data D0 in the RAM.

In step S222, as the input processing unit 254, the computation unit 250 inputs the processing target data D0 stored in the RAM to the N×N data processing unit 256B. As the N×N data processing unit 256B, the computation unit 250 performs the 1×1 convolution operation C1.

In step S224, as the N×N data processing unit 256B, the computation unit 250 outputs the processing result data D1 of the 1×1 convolution operation C1 to the first output processing unit 258A. As the first output processing unit 258A, the computation unit 250 stores the processing result data D1 in the RAM.

In step S226, as the first output processing unit 258A, the computation unit 250 outputs the processing result data D1 stored in the RAM to the input processing unit 254. As the input processing unit 254, the computation unit 250 stores the processing result data D1 in the RAM.

In step S228, as the input processing unit 254, the computation unit 250 inputs the processing result data D1 stored in the RAM to the M×M data processing unit 256A. As the M×M data processing unit 256A, the computation unit 250 performs the 3×3 convolution operation C2.

In step S230, as the M×M data processing unit 256A, the computation unit 250 outputs the processing result data D2 of the 3×3 convolution operation C2 to the second output processing unit 258B. As the second output processing unit 258B, the computation unit 250 stores the processing result data D2 in the RAM.

In step S232, as the second output processing unit 258B, the computation unit 250 transfers the processing result data D2 stored in the RAM to the external memory 52.

In step S234, the control unit 250 determines whether to end the repeated processing. If the control unit 250 determines that the repeated processing is not to be ended, the processing returns to step S220 and the control unit 50 repeats steps S220 to S234. On the other hand, if the control unit 50 determines that the repeated processing is to be ended, the convolution operation control processing is ended.

In the above-described example, the magnitude relationship between the number of input channels Cin and the number of output channels Cout is the same among the convolution layers. However, as in the first embodiment, the magnitude relationship between the number of input channels Cin and the number of output channels Cout may be changed at an intermediate convolution layer in the neural network.

As described above, in the data processing apparatus according to the second embodiment, the first output processing unit outputs the result of the convolution operation performed by either one of the M×M data processing unit and the N×N data processing unit to the input processing unit. The second output processing unit transfers the result of the convolution operation by the other of the M×M data processing unit and the N×N data processing unit to the external memory. This makes it possible to achieve speedup of the convolution processing while suppressing an increase in the number of accesses to the external memory. Specifically, two convolution operations can be performed in parallel, so that the number of times the feature amount of large size is saved in the external memory is decreased to half.

In the data processing apparatus according to the second embodiment, if the number of data items belonging to the third axis in the data of result of the M×M convolution processing is smaller than the number of data items belonging to the third axis in the data of result of the N×N convolution processing, the result of processing by the M×M data processing unit is stored in the second output buffer unit. Then, the result of processing by the N×N data processing unit is stored in the first output buffer unit. This makes it possible to suppress transfer to the external memory while assuring a reduction in the number of operations on the network of the structure of the decomposition method 1.

In the data processing apparatus according to the second embodiment, if the number of data items belonging to the third axis in the data of result of the N×N convolution processing is smaller than the number of data items belonging to the third axis in the data of result of the M×M convolution processing, the result of processing by the N×N data processing unit is stored in the second output buffer unit. Then, the result of processing by the M×M data processing unit is stored in the first output buffer unit. This makes it possible to suppress transfer to the external memory while assuring a reduction in the number of operations on the network of the structure of the decomposition method 2.

The present disclosure has been described in accordance with the embodiments, but it should be understood that the present disclosure is not limited to the embodiments and structures. The present disclosure also includes various modification examples and modifications within the scope of equivalence. In addition, various combinations and modes, and other combinations and modes including only one element of the foregoing combinations and modes, less or more than the one element are included in the scope and conceptual range of the present disclosure.

What is claimed is:

1. A data processing apparatus comprising:
an external memory that stores processing target data;
an input buffer unit that stores at least part of the data stored in the external memory;
an M×M data processing unit that performs M×M convolution processing using the data stored in the input buffer unit;
an N×N data processing unit that performs N×N convolution processing using the data stored in the input buffer unit;
a first output buffer unit that stores one of results of processing by the M×M data processing unit and the N×N data processing unit; and
a second output buffer unit that stores the other of the results of processing by the M×M data processing unit and the N×N data processing unit, wherein
the result of processing stored in the first output buffer unit is stored in the input buffer unit, and
the result of processing stored in the second output buffer unit is transferred to the external memory.

2. The data processing apparatus according to claim 1, wherein
M and N are integers greater than or equal to 1, and M>N.

3. The data processing apparatus according to claim 2, wherein N=1.

4. The data processing apparatus according to claim 1, wherein
the processing target data is data defined by three or more orthogonal axes, and
the M×M convolution processing or the N×N convolution processing is performed on a first axis and a second axis in the processing target data.

5. The data processing apparatus according to claim 4, wherein
if the number of data items belonging to a third axis in the data of result of the M×M convolution processing is smaller than the number of data items belonging to the third axis in the data of result of the N×N convolution processing, the result of processing by the M×M data processing unit is stored in the second output buffer unit, and the result of processing by the N×N data processing unit is stored in the first output buffer unit.

6. The data processing apparatus according to claim 4, wherein
if the number of data items belonging to a third axis in the data of result of the N×N convolution processing is smaller than the number of data items belonging to the third axis in the data of result of the M×M convolution processing, the result of processing by the N×N data processing unit is stored in the second output buffer unit, and the result of processing by the M×M data processing unit is stored in the first output buffer unit.

7. The data processing apparatus according to claim 1, wherein
the N×N convolution processing and the M×M convolution processing are performed as part of image processing using a neural network.

8. A computer-readable storage media having instructions stored thereon that, when executed by a computer including an external memory storing processing target data, cause the computer to function as:
an input processing unit that stores at least part of the data stored in the external memory;
an M×M data processing unit that performs M×M convolution processing using the data from the input processing unit;
an N×N data processing unit that performs N×N convolution processing using the data from the input processing unit;
a first output processing unit that stores one of results of processing by the M×M data processing unit and the N×N data processing unit; and
a second output processing unit that stores the other of the results of processing by the M×M data processing unit and the N×N data processing unit, wherein
the first output processing unit stores the result of processing in the input processing unit, and
the second output processing unit transfers the result of processing to the external memory.

9. The computer-readable storage media according to claim 8, wherein
M and N are integers greater than or equal to 1, and M>N.

10. The computer-readable storage media according to claim 9, wherein N=1.

11. The computer-readable storage media according to claim 8, wherein
the processing target data is data defined by three or more orthogonal axes, and
the M×M convolution processing or the N×N convolution processing is performed on a first axis and a second axis in the processing target data.

12. The computer-readable storage media according to claim 11, wherein
if the number of data items belonging to a third axis in the data of result of the M×M convolution processing is smaller than the number of data items belonging to the third axis in the data of result of the N×N convolution processing, the result of processing by the M×M data processing unit is stored in the second output processing unit, and the result of processing by the N×N data processing unit is stored in the first output processing unit.

13. The computer-readable storage media according to claim 11, wherein
if the number of data items belonging to a third axis in the data of result of the N×N convolution processing is smaller than the number of data items belonging to the third axis in the data of result of the M×M convolution processing, the result of processing by the N×N data processing unit is stored in the second output processing unit, and the result of processing by the M×M data processing unit is stored in the first output processing unit.

14. The computer-readable storage media according to claim 8, wherein
the N×N convolution processing and the M×M convolution processing are performed as part of image processing using a neural network.
